(19) United States
(12) Patent Application Publication
(10) Pub. No.: US 2026/0281270 A1
(43) Pub. Date: Sep. 17, 2026

(54) IMAGE READING APPARATUS AND METHOD OF CONTROLLING THE SAME

(71) Applicant: CANON KABUSHIKI KAISHA, Tokyo (JP)

(72) Inventor: SATOSHI YOSHIDA, Tochigi (JP)

(21) Appl. No.: 19/563,008

(22) Filed: Mar. 11, 2026

(30) Foreign Application Priority Data
Mar. 17, 2025 (JP) 2025-042624

(51) Int. Cl. H04N 1/00; H04N 1/387

(52) U.S. Cl. CPC H04N 1/00814; H04N 1/00718; H04N 1/00745; H04N 1/3878

(57) ABSTRACT

An image reading apparatus comprises a first image reader including a first light source on an upstream side and a second light source on a downstream side and reads a first side of a document with light emitted by the first and the second light sources, and a second image reader including a third light source on an upstream side and a fourth light source on a downstream side and reads a second side of the document with light emitted by the third and fourth light sources. When adjusting the light amounts of the third and fourth light sources, the apparatus adjusts a second total light amount in which the light amounts of the third and fourth light sources are added based on a first total light amount in which the light amounts of the first and second light sources whose light amounts have been adjusted are added.

### BACKGROUND

### Field of the Technology

The present disclosure relates to an image reading apparatus and a method of controlling the same.

### Description of the Related Art

In a known document reader, an auto document feeder (hereinafter, ADF) conveys, one by one, documents placed on a document tray to read the documents. In Japanese Patent Laid-Open No. 2021-78009, a front side of a document is read by a first reader fixed to a predetermined first reading position (hereinafter, flow reading position), and a back side of the document is read by a second reader at a second reading position on a downstream side in a conveyance direction relative to the flow reading position.

There is room for improvement in adjustment of a light amount in the known document reader.

### SUMMARY

Embodiments of the present disclosure eliminate the above-mentioned issues with conventional technology.

According to embodiments of the present disclosure, there is provided an image reading apparatus that reads a document conveyed by a conveyor, the image reading apparatus comprising: a first image reader that includes a first light source disposed on an upstream side in a conveyance direction of the document and a second light source disposed on a downstream side in the conveyance direction, and reads a first side of the document with light emitted by the first light source and the second light source; a second image reader that includes a third light source on an upstream side in the conveyance direction of the document and a fourth light source on a downstream side in the conveyance direction, and reads a second side different from the first side of the document with light emitted by the third light source and the fourth light source; and one or more controllers including one or more processors in communication with one or more memories, the one or more controllers configured to: be able to adjust a light amount of the first light source and light amount of the second light source, and be able to adjust a light amount of the third light source and light amount of the fourth light source wherein when adjusting the light amount of the third light source and the light amount of the fourth light source, the one or more controllers adjust a second total light amount in which the light amount of the third light source and the light amount of the fourth light source are added based on a first total light amount in which the light amount of the first light source and the light amount of the second light source whose light amounts have been adjusted are added.

Further features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 depicts a cross-sectional view of a document reader according to a first embodiment of the present disclosure.

FIGS. 2A and 2B depict views for describing a configuration of a front-side reader of the document reader according to the first embodiment.

FIG. 3A is a distribution diagram of a light amount on an upstream side in a conveyance direction and a light amount on a downstream side in the conveyance direction at a main scanning position of the document reader according to the first embodiment.

FIG. 3B depicts an enlarged view of a periphery of a front-side reading position F at an area 301 of FIG. 3A.

FIG. 3C depicts an enlarged view of a periphery of the front-side reading position F at an area 300 of FIG. 3A.

FIG. 4 depicts a view illustrating a relationship between intensities of a light amount on an upstream side and a light amount on a downstream side and a shadow in the front-side reader of the document reader according to the first embodiment.

FIG. 5 is a block diagram for describing a configuration of a control unit of the document reader according to the first embodiment.

FIG. 6A is a block diagram for describing a configuration of the front-side reader according to the first embodiment.

FIG. 6B depicts a view for describing control and light amount of an upstream side LED and a downstream side LED of the front-side reader.

FIG. 6C depicts a view for describing control and light amount of the upstream side LED and the downstream side LED of a back-side reader.

FIG. 7 depicts a view for describing processing by an edge extraction module according to the first embodiment.

FIG. 8 depicts a view for describing a method for calculating registration in a front-side registration calculation module according to the first embodiment.

FIGS. 9A and 9B depict views for describing processing of registration correction by a registration correction module according to the first embodiment.

FIG. 10 depicts a view for describing difference information stored in a nonvolatile memory in the first embodiment.

FIGS. 11A and 11B are flowcharts for describing processing of setting lighting conditions of the upstream side LED and the downstream side LED of the front-side reader in the document reader according to the first embodiment.

FIGS. 12A and 12B are flowcharts for describing control processing of setting lighting conditions of the upstream side LED and the downstream side LED of the back-side reader in the document reader according to the first embodiment.

FIG. 13A is a flowchart for describing processing corresponding to step S215 of the flowchart of FIG. 12B according to a second embodiment.

FIG. 13B is a flowchart for describing processing corresponding to step S215 of the flowchart of FIG. 12B according to a third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

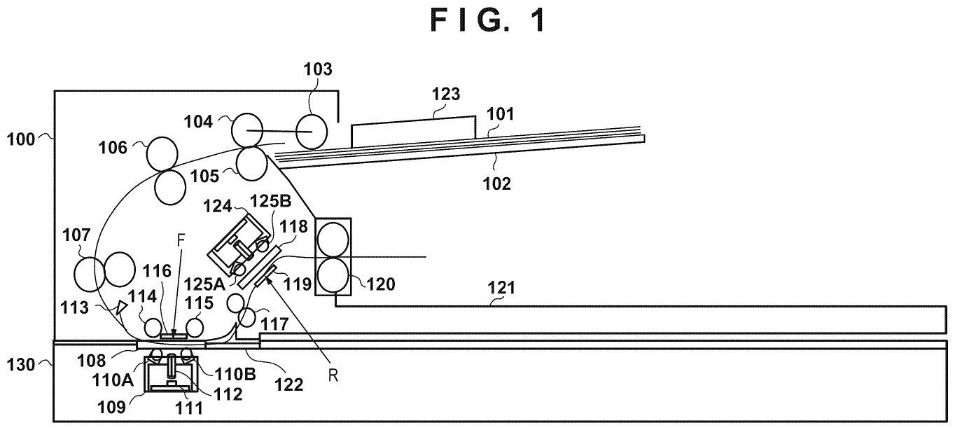

FIG. 1 depicts a cross-sectional view of a document reader 100 according to the first embodiment of the present disclosure.

The document reader 100 includes a document tray 102 on which a document 101 is placed. A plurality of documents 101 can be stacked on the document tray 102, and side regulating plates 123 that press the stacked documents from a front side and a rear side of FIG. 1 are disposed. These side regulating plates 123 can move so that the documents placed on the document tray 102 come to the center of the document tray 102. As the side regulating plates 123 move, a volume resistor (not illustrated) installed inside the document tray 102 is interlocked, and the width of the documents can be detected from the resistance value of this volume resistor.

When a document reading start instruction is input, a front-side reader 109 is moved under a white reference plate 122 on the right side of front-side flow reading glass 108 by a stepping motor (not illustrated) and a belt (not illustrated). Then, the white reference plate 122 is read so that the sensitivity of the sensor in the main scanning direction becomes uniform to obtain shading data. At the same time as this, a back-side reader 124 reads a back-side guide plate 119 also serving as a white reference plate, which is a reference reading member on the opposite side, to obtain shading data.

Among the documents placed on the document tray 102, the documents are fed into the apparatus one by one by rotation of a pickup roller 103 in order from the document placed at the top. Note that the pickup roller 103 is rotationally driven by a motor not illustrated.

Since the pickup roller 103 feeds the document 101 only by the frictional force, a plurality of documents may be simultaneously fed based on the friction coefficient of the document 101. Therefore, a separation roller 104 and a separation roller 105 separate the documents one by one. Note that in the first embodiment, the separation roller 104 rotates in the direction of conveying the document, and the separation roller 105 does not rotate.

The document 101 separated into one sheet by the separation roller 104 and the separation roller 105 is conveyed to the downstream side by rotation of a pair of front conveyance rollers 106. Thereafter, the document 101 is conveyed to the front-side reading position F of the document 101 by a pair of lead rollers 107.

The front-side flow reading glass 108, which is transparent, is disposed below the front-side reading position F, and the front side of the document 101 is read by the front-side reader 109 stopped further therebelow.

The front-side reader 109 is provided with an LED 110A, which is a light source that emits light toward the document 101 from the upstream side in the conveyance direction of the document, an LED 110B, which is a light source that emits light toward the document from the downstream side in the conveyance direction, an image sensor 111, and an optical component 112. Then, the LED 110A and the LED 110B illuminate the front side of the document 101, and the reflected light thereof is condensed on the image sensor 111 by the optical component 112, thereby reading the front side of the document 101.

A sheet detection sensor 113 that detects the leading edge of the document 101 is disposed upstream of the front-side reading position F. A controller 200 (FIG. 5) described later receives digital image data from the front-side reader 109 at a predetermined timing between the timing when the sheet detection sensor 113 detects the leading edge of the document and the timing when the leading edge of the document 101 reaches the front-side reading position F. The controller 200 detects the size of the document in a sub-scanning direction (conveyance direction) from the on time of the sheet detection sensor 113 (time when the document 101 is being detected).

Here, if the document is read in a state where the posture of the document 101 is unstable, the distance between the front-side reader 109 and the document 101 is not stabilized, and a shadow cast by the leading edge portion of the document described later is not stabilized. Therefore, the document 101 is pressed from above by an upstream side pressing roller 114 and a downstream side pressing roller 115. A front-side guide plate 116, which is a white background portion, is disposed at a position facing the front-side reader 109 between the upstream side pressing roller 114 and the downstream side pressing roller 115.

The document 101 having passed through the front-side reading position F is further conveyed downstream by a pair of rear conveyance rollers 117 and conveyed to a back-side reading position R. Transparent back-side flow reading glass 118 is disposed above the back-side reading position R, and the back side of the document 101 is read by the back-side reader 124 disposed further thereabove. Note that the back-side reader 124 in the first embodiment has substantially the same configuration as that of the front-side reader 109, and includes an LED 125A, which is a light source that emits light toward the document from the upstream side, and an LED 125B, which is a light source that emits light toward the document from the downstream side.

The back-side reader 124 is controlled by the controller 200 described below. The controller 200 starts receiving the digital image data output from the back-side reader 124 at a predetermined timing between the timing when the sheet detection sensor 113 detects the leading edge of the document and the timing when the leading edge of the document 101 reaches the back-side reading position R.

The back-side guide plate 119, which is a white background portion, is disposed at a position facing the back-side reader 124. The back-side guide plate 119 also serves as a white reference plate, which is a reference reading member, so as to obtain shading data of the back side. Therefore, the configuration of the back-side guide plate 119 with respect to the back-side reader 124 is different from the configuration of the front-side guide plate 116 with respect to the front-side reader 109. Note that immediately after the reading is started, the back-side reader 124 reads the back-side guide plate 119 also serving as a white reference plate, which is a reference reading member on the opposite side, to obtain shading data.

The document 101 having passed through the back-side reading position R is discharged out of the apparatus by a pair of paper discharge rollers 120. The document 101 discharged in this manner is placed on a paper discharge tray 121. Then, the document reader 100 is attached to a document platform unit 130 so as to be positioned against the front-side flow reading glass 108.

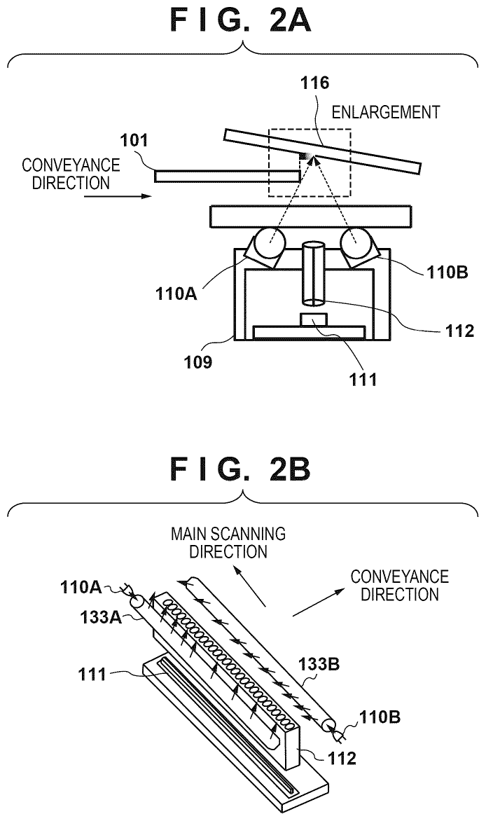

FIGS. 2A and 2B depict views for describing a configuration of the front-side reader 109 of the document reader 100 according to the first embodiment.

FIG. 2A depicts a view illustrating a cross-sectional structure of the front-side reader 109. The document 101 is conveyed from the left side (upstream in the conveyance direction) to the right side (downstream in the conveyance direction) in the drawing, and information on the front side of the document 101 is read by the front-side reader 109.

The front-side reader 109 has a width in the main scanning direction (direction intersecting the conveyance direction) in order to read the size (width) of the document 101 that is conveyed. Then, as illustrated in FIG. 2B, the upstream side LED 110A and the downstream side LED 110B are arranged so that light from the LEDs 110A and 110B is incident on the edge portion of the front-side reader 109 from directions facing each other. Light emitted from the LEDs 110A and 110B is incident on light guides 133A and 133B, and is emitted with an angle changed in the direction of the sheet passing surface through which the document 101 passes by slits and irregularities (not illustrated) of the light guides 133A and 133B. At this time, ideally, the light guides 133A and 133B emit light so as to be uniform with respect to the main scanning direction, but in practice, variation in light intensity occurs depending on the position of the main scanning. This is due to the way the light of the LEDs 110A and 110B spreads, manufacturing errors of slits and irregularities of the light guides 133A and 133B, variations in the light amounts of the LED 110A and the LED 110B, and the like. The slits and irregularities of the light guides 133A and 133B are not uniformly arranged but are arranged such that the light amounts of the light guides 133A and 133B are matched to become uniform in the main scanning direction with respect to the document side. Therefore, for example, at a certain position in the main scanning, the light amount of the light guide 133B tends to decrease at a position where the light amount of the light guide 133A is high. Then, in the first embodiment, the light guide 133A on the upstream side and the light guide 133B on the downstream side use the same light guide, and the same light guide is installed on the upstream side and the downstream side in a left-right reversed manner. By doing this, the configuration ensures that, when both the light guide 133A on the upstream side and the light guide 133B on the downstream side are caused to emit light, the light amount irradiating the document side becomes as uniform as possible in the main scanning direction.

In such a document reader 100, the document may be conveyed in an inclined manner with respect to the front-side reader 109 due to separation pressure of the document, sliding resistance of the document tray, a manufacturing error of a roller diameter used at the time of document conveyance, and the like. If reading of the document is performed by the front-side reader 109 while being conveyed in an inclined manner as described above, image data of an oblique document is obtained, which is not preferable for the user. Therefore, in order to correct the inclination of the document by detecting the inclination of the document from the shadow generated by the leading edge portion of the conveyed document, the shadow cast by the leading edge portion of the document is projected on the front-side guide plate 116, which is a background portion disposed on the upper side of the reading position. Then, the inclination and width of the document and the position information of the edge portion of the document are detected from the result of extracting the edge of the shadow appearing on the front-side guide plate 116, and skew correction is applied to the inclination of the document.

In a case where a shadow generated by the leading edge portion of this document is detected, the light emitted from the LED 110A on the upstream side in the conveyance direction is light that creates the shadow generated by the leading edge portion. On the other hand, the light emitted from the downstream side LED 110B in the conveyance direction is light that cancels the shadow generated by the leading edge portion. If the light from the downstream side LED 110B that cancels the shadow is strong, the shadow cast by the leading edge portion disappears or the shadow is interrupted depending on the position of the main scanning, and the shadow cast by the leading edge portion cannot be correctly detected.

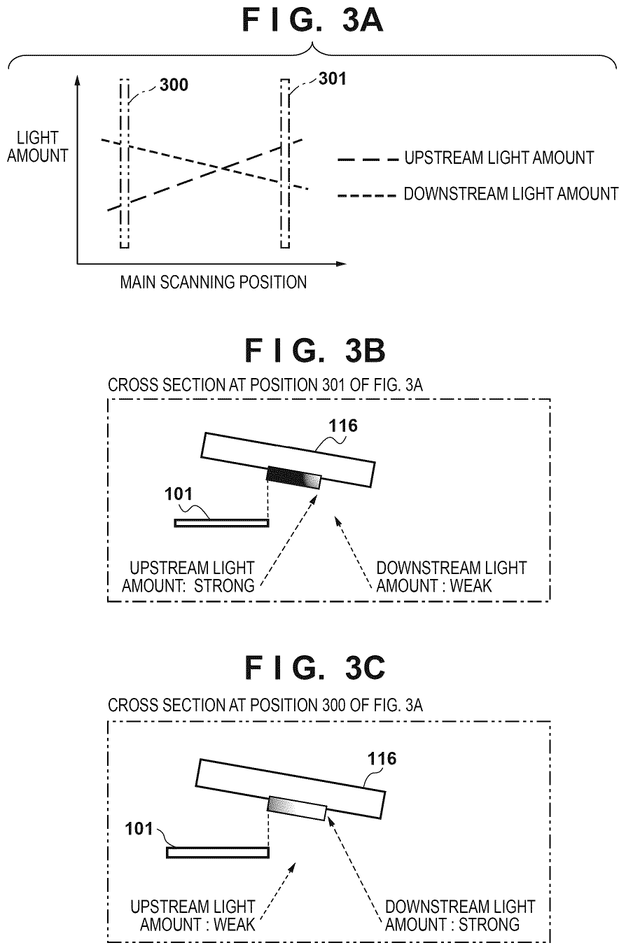

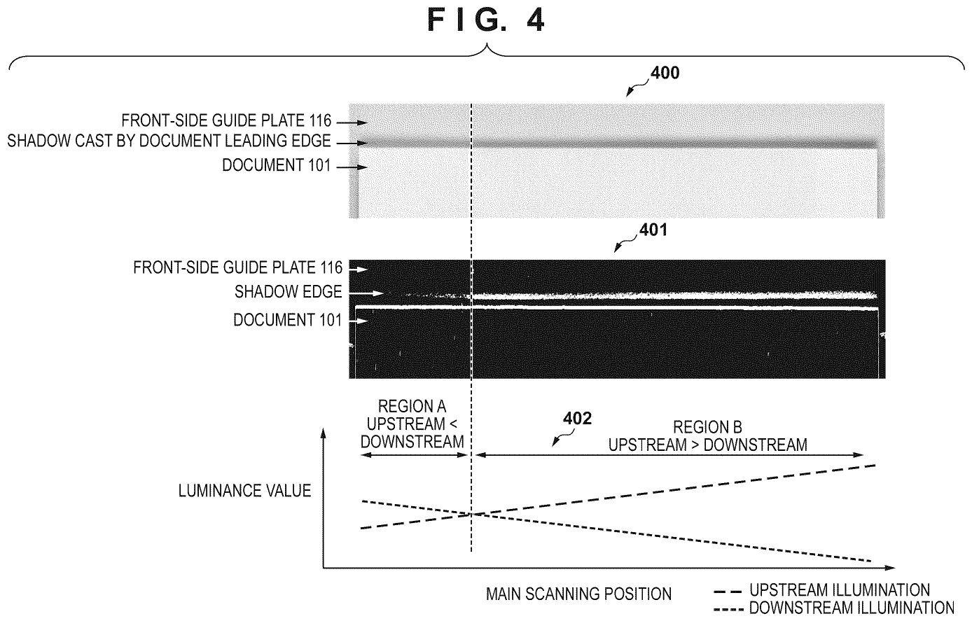

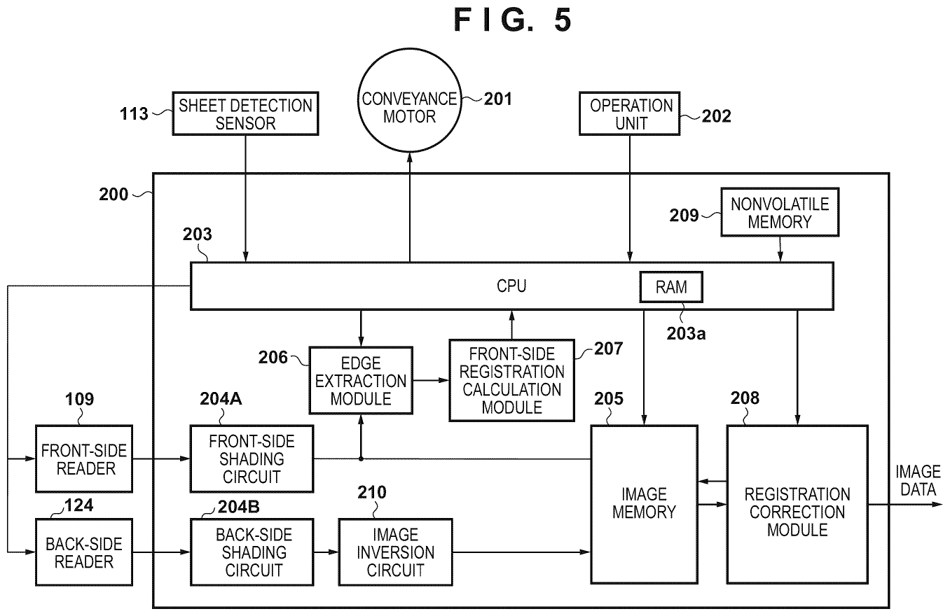

FIG. 3A is a distribution diagram of the light amount on the upstream side in the conveyance direction and the light amount on the downstream side in the conveyance direction at the main scanning position of the document reader 100 according to the first embodiment. As described above, the light amount on the upstream side in the conveyance direction and the light amount on the downstream side in the conveyance direction are different from each other depending on the main scanning position as illustrated in FIG. 3A. The influence on the shadow generated by the leading edge portion of the document 101 due to the difference in the light amount between the upstream side and the downstream side will be described with reference to FIGS. 3B and 3C.

The front-side guide plate 116 is obliquely arranged such that a path interval of the document 101 narrows toward the downstream side in the conveyance direction. The gradation of the shadow is controlled by this inclination, and the light amount on the upstream side and the light amount on the downstream side described later. In the first embodiment, the front-side guide plate 116 is disposed with an inclination of 2 degrees from the horizontal. Note that the larger the inclination on the upstream side, the darker the shadow becomes, and conversely, the shadow becomes lighter when the inclination is applied so that the downstream side becomes high. The greater the distance between the front-side guide plate 116 and the document 101, the lighter the shadow becomes, and the shorter the distance, the darker the shadow becomes.

The light emitted from the light guide 133A on the upstream side is light that creates the shadow generated by the leading edge portion of the document 101 on the front-side guide plate 116. On the other hand, the light emitted from the light guide 133B on the downstream side is light that cancels the shadow cast by the leading edge portion of the document 101 projected on the front-side guide plate 116 by the light emitted from the upstream side. An area 301 at the main scanning position in FIG. 3A corresponds to an area in which the light amount on the upstream side is higher than the light amount on the downstream side. An enlarged view around the front-side reading position F in this area 301 is illustrated in FIG. 3B. In the example of FIG. 3B, the light amount on the downstream side is weaker than the light amount on the upstream side with respect to the shadow cast by the leading edge portion generated by the light on the upstream side, and the light amount to cancel the shadow is smaller. Therefore, a dark shadow is projected on the front-side guide plate 116.

On the other hand, the area 300 at the main scanning position in FIG. 3A corresponds to an area where the light amount on the downstream side is high with respect to the light amount on the upstream side. An enlarged view around the front-side reading position F in this area 300 is illustrated in FIG. 3C. In the example of FIG. 3C, the light amount on the downstream side is stronger than the light amount on the upstream side with respect to the shadow cast by the leading edge portion of the document 101 generated by the light amount on the upstream side, and therefore the light amount to cancel the shadow is large. Therefore, the shadow projected on the front-side guide plate 116 becomes light.

This relationship between the intensity of the light amount and the shadow is the same for both the front-side reader 109 and the back-side reader 124, but there is a case where it is difficult to provide a guide portion with a configuration that is similar on both the front and back.

The front-side guide plate 116, which is on the opposite side of the front-side reading position F, is relatively easily configured to create a dark shadow such as by increasing the angle. Therefore, the shadow cast by the document 101 is detected by the front-side reader 109, and document information such as position and inclination of the document 101 is obtained. Then, the read image of the document 101 is rotated or moved based on the obtained information, and is corrected so that image data obtained by reading becomes image data of a straight document. On the other hand, the back-side reader 124 does not obtain document information such as position and inclination of the document 101, and corrects the read image data using the document information obtained by the front-side reader 109. Note that the positional relationship between the front-side reader 109 and the back-side reader 124, the difference in angle at the time of reading, and the like need to be obtained in advance at the time of factory shipment or installation. Doing this makes it possible to correct each of the image data of the front side and the image data of the back side of the document by using the document information detected by the front-side reader 109.

FIG. 4 depicts a view for describing the relationship between intensities of the light amount on the upstream side and the light amount on the downstream side and the shadow in the front-side reader 109 of the document reader 100 according to the first embodiment and a shadow.

In FIG. 4, reference numeral 400 denotes a digital image obtained by reading the front-side guide plate 116, the shadow cast by the document leading edge, and the image of the document 101. Since the front-side reader 109 starts reading before the document 101 is conveyed to the reading position F (FIG. 1), it reads the front-side guide plate 116 on the upper side where the reading is started. Then, as the conveyance and reading of the document 101 proceed, the shadow cast by the leading edge of the document 101 and the document 101 are read in this order as illustrated in the lower part of the digital image 400. Note that the horizontal direction of FIG. 4 indicates main scanning.

Reference numeral 401 denotes a binarized image in which edge extraction is performed from the read digital image 400. Note that although the method of edge extraction will be described later, white portions are portions determined as edge pixels. The image data obtained by reading the front-side guide plate 116 has almost no edge pixels determined as an edge, and edge pixels are seen at the boundary (shadow edge) between the front-side guide plate 116 and the shadow cast by the leading edge of the document 101. This indicates that there are edge pixels at the boundary between the shadow cast by the document leading edge and the document 101, and there is no edge pixel in the document 101. In the first embodiment, an edge is detected at a shadow portion that is a boundary between the front-side guide plate 116 and the shadow cast by the leading edge of the document 101, and image data in which the document 101 is read with skew is corrected. It is indicated that at the shadow edge of the binarized image 401, there is an interruption of the edge pixels of the shadow on the left side, and there is no edge pixel in the left edge portion of the document 101. Since there is no edge pixel in the edge portion of the shadow portion that is originally desired to be detected, the inclination of the document 101 or the edge portion of the document 101 may be erroneously detected, and erroneous correction may be performed. A method of correcting the inclination and the edge position of the document 101 will be described later in front-side registration correction.

Reference numeral 402 denotes a graph showing the upstream and downstream light amounts at the main scanning position when the read digital image 400 is obtained. The intensity of the upstream and downstream light amounts and the detection of the edge will be described using the binarized image 401 and the graph 402. In a case where the light amount on the downstream side is higher than the light amount on the upstream side as in a region A of the graph 402, the light to cancel the shadow (on the downstream side) becomes stronger, and therefore the shadow becomes lighter. For this reason, as illustrated in the binarized image 401, there is a case where an edge pixel of an edge portion of a shadow portion is interrupted and the edge pixel cannot be detected. On the other hand, in a case where the light amount on the upstream side is higher than the light amount on the downstream side as in a region B, the light that creates the shadow becomes stronger and the shadow becomes dark. Thus, the edge pixels are detected in the shadow edge portion in the region B rather than in the region A, and the shadow edge can be detected with high accuracy.

Therefore, by adjusting the lighting time and the current value of the upstream side LED 110A and the downstream side LED 110B so that the light amounts on the upstream side and the downstream side have a relationship of (upstream>downstream), it is possible to accurately detect the shadow edge generated in the background portion of the document 101.

Note that in the first embodiment, the edge pixels are not correctly detected in the region of (upstream<downstream), but the relationship between the intensity of the upstream and downstream light amounts and the ease of edge detection changes depending on the angle of the front-side guide plate 116, the distance to the document, the threshold at the time of edge determination, and the like.

FIG. 5 is a block diagram for describing the configuration of a control unit of the document reader 100 according to the first embodiment.

The front-side reader 109, the back-side reader 124, and the sheet detection sensor 113 described above are connected to the controller (control unit) 200. A conveyance motor 201 for rotationally driving each roller described above for conveying a document, and an operation unit 202 for instructing a reading operation from a user are further connected to the controller 200.

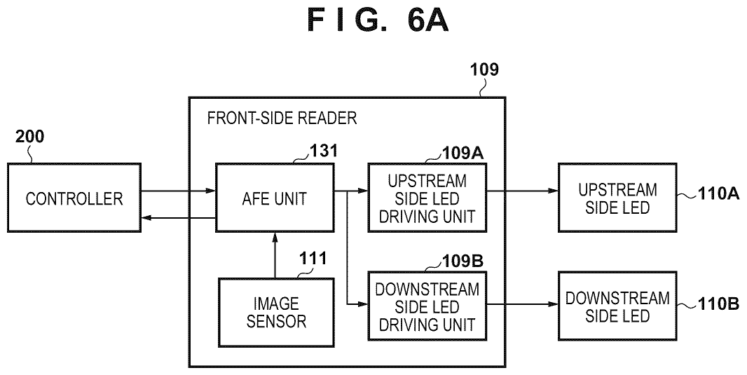

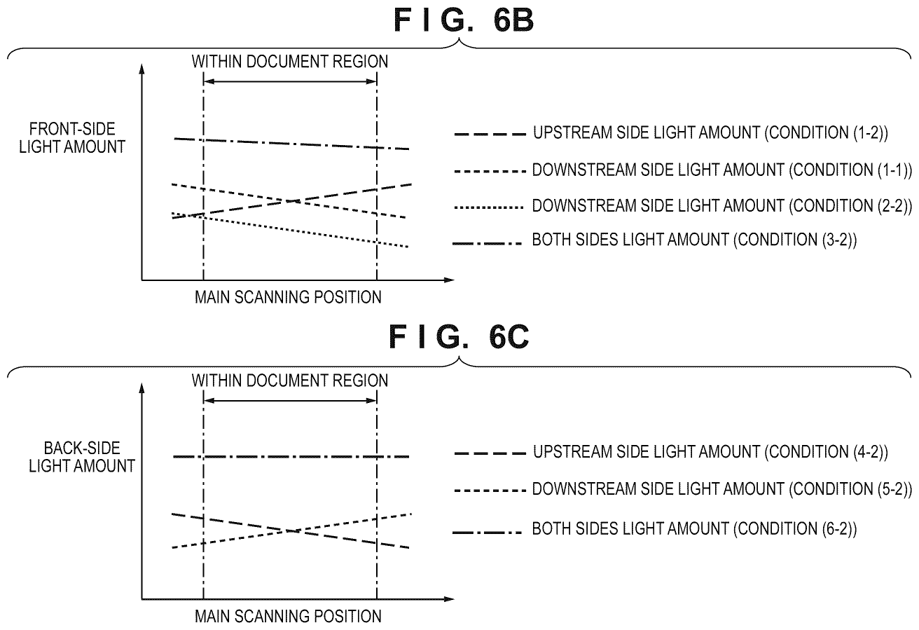

The controller 200 includes a CPU 203 that controls the document reader 100 including the front-side reader 109 and the back-side reader 124, and each image processing module described later. By executing a program stored in a nonvolatile memory 209, the CPU 203 starts control of the document reader 100 in response to an instruction from the operation unit 202. When an instruction to read a document is given from the operation unit 202, the CPU 203 drives the conveyance motor 201 to convey the document 101 and drives the front-side reader 109 and the back-side reader 124. Note that details of the front-side reader 109 and the back-side reader 124 will be described later with reference to FIG. 6. A RAM 203a provides a work memory or the like that temporarily stores various data when the CPU 203 executes control processing.

Digital image data output from the front-side reader 109 is input to a front-side shading circuit 204A in the controller 200, and digital image data output from the back-side reader 124 is input to a back-side shading circuit 204B. The front-side shading circuit 204A and the back-side shading circuit 204B correct nonuniformity of the light amounts of the upstream side LED and the downstream side LED by performing addition and/or subtraction and multiplication and/or division on the input digital image data. Furthermore, the influence of the sensitivity of each pixel of the image sensor 111 is corrected to generate image data that is uniform in the main scanning direction.

The image data of the front side and the image data of the back side that are subjected to shading correction are stored in an image memory 205 at a predetermined timing. In this manner, the image data thus stored in the image memory 205 is read by the CPU 203, and is used to perform an operation and calculate a maximum value and a minimum value of the image data, an average value within a predetermined range, and the like.

The image data of the front side subjected to the shading correction is also sent to an edge extraction module 206 that extracts, as an edge, the shadow cast by the document generated at the document leading edge portion. Since the edge extraction module 206 is intended for edge detection, the image data to be input to the edge extraction module 206 may be only image data around the shadow cast by the document over the entire region in the main scanning direction (document width direction).

Image data of an edge extracted by the edge extraction module 206 is sent to a front-side registration calculation module 207, and the inclination and width of the document, which are document information, are calculated. The document information calculated by the front-side registration calculation module 207 is transmitted to the CPU 203. Details of the edge extraction module 206 and the front-side registration calculation module 207 will be described later.

The document information calculated by the front-side registration calculation module 207 is sent to the CPU 203, and is input from the CPU 203 to a registration correction module 208. The registration correction module 208 reads, while performing registration correction, the image data of the front side stored in the image memory 205 based on the document information. The registration correction module 208 will be described in detail below.

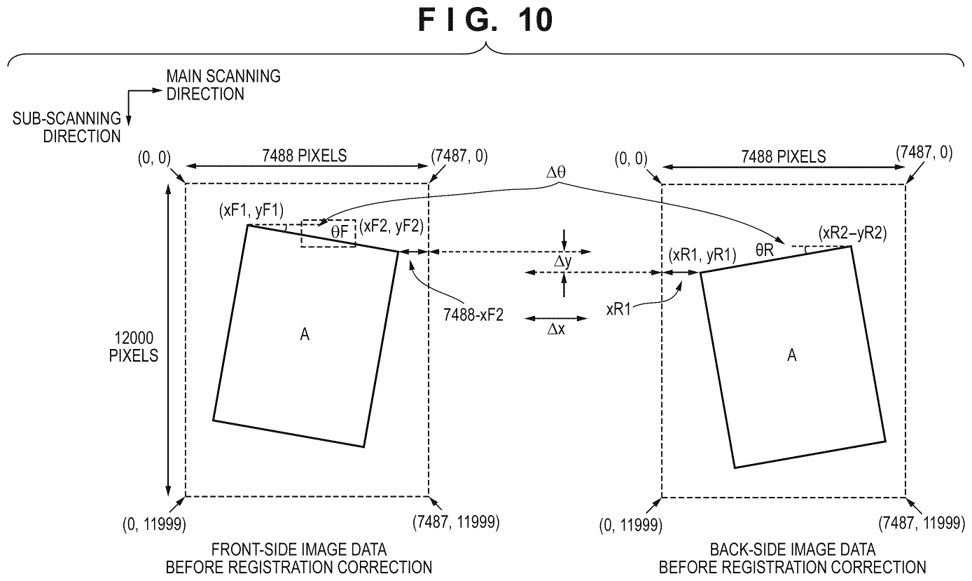

It is possible to store, in the nonvolatile memory 209, operation conditions such as the lighting time and driving current value at the time of turning on the LEDs 110A and 110B of the front-side reader 109. Reading of data stored in the nonvolatile memory 209 is performed according to a drive instruction from the CPU 203. Note that driving conditions (1-1), (2-1), and the like of the LEDs described later with reference to FIG. 10 are stored in the nonvolatile memory 209.

Note that the image data of the back side passes through an image inversion circuit 210 before being stored in the image memory 205. The configuration of the back-side reader 124 according to the first embodiment is substantially the same as that of the front-side reader 109, and the back-side reader 124 is attached in a vertically inverted manner without changing the orientation in the main scanning direction with respect to the front-side reader 109. Therefore, the image data obtained by the back-side reader 124 reading the back side of the document is an image inverted in the main scanning direction. Therefore, before being stored in the image memory 205, the image data of the back side is further inverted in the main scanning direction by the image inversion circuit 210, and normal image data is generated.

FIG. 6A is a block diagram for describing the configuration of the front-side reader 109 according to the first embodiment.

When a drive instruction is given from the CPU 203 to the front-side reader 109, the CPU 203 and an analog front end (AFE) unit 131 start communication. According to the reading mode, the AFE unit 131 instructs an upstream side LED driving unit S116 that drives the upstream side LED 110A and a downstream side LED driving unit 109B that drives the downstream side LED 110B to turn on the corresponding LEDs 110A and 110B, respectively. The AFE unit 131 controls the lighting time and driving current at the time of turning on each of the LEDs 110A and 110B. Specifically, by transmitting the driving condition of the LED stored in the nonvolatile memory 209 from the CPU 203 to the AFE unit 131, the AFE unit 131 can turn on the LED under a predetermined driving condition of the LED. Reflected light and diffused light of light emitted to the front-side guide plate 116 and the document 101 are condensed on the image sensor 111 by the optical component 112, and the condensed light is converted into analog image data by the image sensor 111. The analog image data generated by the image sensor 111 is sent to the AFE unit 131, and converted into 8-bit (0 to 255) digital image data to be transmitted to the controller 200. Note that this digital image data exhibits a higher numerical value as the intensity of light is stronger. Hereinafter, this level is expressed as a luminance value. The CPU 203 can calculate the luminance value received by the controller 200 to control the lighting time and driving current of the LED driven by the AFE unit 131. Note that the back-side reader 124 has substantially the same configuration as that of the front-side reader 109.

FIG. 6B depicts a view for describing control and light amount of the upstream side LED 110A and the downstream side LED 110B of the front-side reader 109. In the first embodiment, the LEDs 110A and 110B are turned on with the lighting time of 300 μs and the driving current of 50 mA, which are condition (condition (1-1)) set in advance as a reference. It is assumed that at this time, the front-side reader 109 is moved below the white reference plate 122 and turned on, and the luminance value each read under this lighting condition does not reach “255”, which is a luminance value reaching saturation, or a predetermined value (e.g., 200) slightly smaller than that. If saturation has been reached, the lighting time is shortened, and a lighting time that has not reached saturation is defined as a reference (condition (1-1)).

The light amounts of the upstream side LED 110A and the downstream side LED 110B are measured so that the shadow edge can be detected, and the lighting condition of the LED is changed. The lighting condition of the downstream side LED 110B is changed such that when the upstream side LED 110A is turned on, the luminance value in a document region when the downstream side LED 110B is turned on becomes smaller than the minimum luminance value in the document region. In the first embodiment, the lighting condition is changed such that the downstream side LED 110B becomes darker than the minimum value in the document region of the upstream side LED 110A turned on under condition (1-1). In the first embodiment, a condition in which the lighting time is set to 50% of that of condition (1-1) and the driving current is set to 50 mA is defined as condition (2-1). Under this condition (2-1), the downstream side LED 110B is turned on, and it is confirmed that the maximum value in the document region at this time is smaller than the minimum luminance value in the document region when the upstream side LED 110A is turned on under the lighting condition (1-1). Here, if it is not smaller, the lighting time is shortened and adjusted as condition (2-1), and finally overwritten and stored as condition (2-1).

Then, the upstream side LED 110A is turned on under condition (1-1), and the downstream side LED 110B is turned on under condition (2-1), and the white reference plate at this time is read. In this manner, the condition when turning on both the LED 110A and the LED 110B on both sides is defined as condition (3-1). Then, it is determined whether the maximum value of the luminance value of the entire main scanning region read with both turned on is the predetermined value (e.g., “200”) or more. In a case of the predetermined value or more, the lighting time of the lighting condition of each of the LEDs 110A and 110B is reduced at the same ratio, and fine adjustment is performed such that the luminance value becomes smaller than the predetermined value. Specifically, the lighting time of the upstream side LED 110A is reduced by 2% from the lighting time in condition (1-1), and the lighting time of the downstream side LED 110B is reduced by 2% from the lighting time in condition (2-1), thereby shortening the lighting time until the luminance value becomes the predetermined value, for example, “200” or less (condition (3-2)). By doing this, it is possible to lower (darken) the light amounts of both LEDs while maintaining the light amount ratio of the upstream side and the downstream side with the relationship of (upstream>downstream), which is the condition under which a shadow easily appears.

In this manner, finally, when turned on under condition (3-2), the condition of the upstream side LED 110A is stored in the nonvolatile memory 209 as condition (1-2), and the condition of the downstream side LED 110B is stored in the nonvolatile memory 209 as condition (2-2). At the time of reading the document, the CPU 203 reads these conditions and reads the front side of the document 101. The maximum luminance value and the minimum luminance value of the light amount in the entire main scanning region under condition (3-2) are also stored in the nonvolatile memory 209.

FIG. 6C depicts a view for describing control and light amount of the upstream side LED 125A and the downstream side LED 125B of the back-side reader 124. As described above, the back-side reader 124 does not obtain document information using the edge portion of a shadow of the document. Therefore, since it is not necessary to adjust the intensity of the light amounts of the upstream side LED 125A and the downstream side LED 125B as described with reference to FIG. 6B, the back-side reader 124 sets the light amounts of the upstream side LED 125A and the downstream side LED 125B substantially equal to each other.

First, with the lighting time of 300 μs and the driving current of 50 mA, which are a condition (condition (4-1)) set in advance, the back-side reader 124 turns on the upstream side LED 125A and the downstream side LED 125B separately to obtain the luminance value. At this time, unlike the front-side reader 109, the back-side reader 124 obtains a read value of reflected light from the back-side guide plate 119 disposed at a position facing the position of the back-side reading position R or a read value of reflected light from a white tool (not illustrated) disposed for adjustment at a position where the document is conveyed. The luminance values read under these lighting conditions are assumed to be less than the predetermined value. In a case of less than the predetermined value, the lighting time is shortened, and the lighting time in a case of less than the predetermined value is defined as a reference (condition (4-1)).

The light amounts of the upstream side LED 125A and the downstream side LED 125B are measured to change the lighting conditions of the LEDs. The lighting condition of each LED is set such that the maximum luminance value in the document region when the upstream side LED 125A is turned on and the maximum luminance value in the document region when the downstream side LED 125B is turned on fall within a predetermined range (within the luminance difference of 10 in the first embodiment). Specifically, in accordance with the smaller maximum luminance value in the document region, the lighting time of the LED having the larger luminance value is shortened and adjusted so as to fall within the predetermined range. The lighting setting of the upstream side LED 125A set at this time is defined as condition (4-1), and the lighting setting of the downstream side LED 125B is defined as condition (5-1) (condition (4-1) is overwritten and stored). The setting when turning on both the upstream side LED 125A and the downstream side LED 125B is defined as condition (6-1).

Then, the light amounts of both the upstream side LED 125A and the downstream side LED 125B are adjusted such that the maximum luminance value in the document region when both LEDs are turned on falls within a predetermined range with the maximum luminance value of the light amount (condition (3-2)) of the front-side reader 109 stored in the nonvolatile memory 209. The condition at this time is defined as (condition (6-1)). The predetermined range described above is, for example, within the luminance difference of 10 in the first embodiment.

Specifically, the lighting time of the upstream side LED 125A is reduced by 2% from the lighting time of condition (4-1), and the lighting time of the downstream side LED 125B is reduced by 2% from the lighting time in condition (5-1). The lighting time of each is shortened until the difference between the maximum luminance value in the document region and the maximum luminance value of the light amount (condition (3-2)) of the front-side reader 109 stored in the nonvolatile memory 209 becomes a luminance difference ±10 or less. In this manner, finally, the condition of the upstream side LED 125A is stored in the nonvolatile memory 209 as condition (4-2), and the condition of the downstream side LED 125B is stored in the nonvolatile memory 209 as condition (5-2), and this condition is read at the time of reading the back side of the document to execute reading of the back side of the document 101. Note that the condition when the LEDs on both the upstream and downstream sides of the back-side reader 124 are turned on is defined as condition (6-2), and is illustrated in FIG. 6C.

Note that in the first embodiment, the condition is set by shortening the lighting time of the LED, but the condition may be set by changing the driving current.

In the first embodiment, the light amounts of the front and back LEDs are adjusted so as to match the maximum luminance value in a document reading region, but adjustment may be performed so as to match the average luminance value in the document reading region.

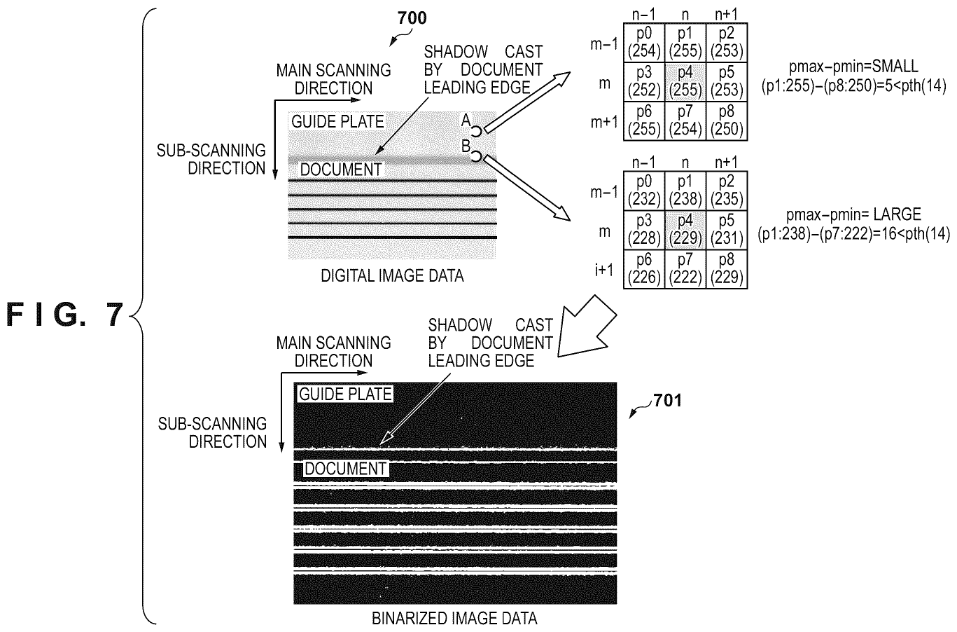

FIG. 7 is a view for describing processing by the edge extraction module 206 according to the first embodiment.

In FIG. 7, reference numeral 700 denotes part of the digital image data obtained by the front-side reader 109.

Image data from the timing before the document reaches the front-side reading position F is input to the edge extraction module 206. Therefore, image data of the white front-side guide plate 116 on the front side facing the front-side reader 109 is also input upstream (upward in FIG. 7) of the document and the shadow cast by the leading edge of the document.

The edge extraction module 206 performs binarization processing on this image data with a region of nine pixels of (three main scanning pixels three sub-scanning pixels) as one block. Note that in FIG. 7, the pixel position in the main scanning direction is denoted by n (1≤n≤7500), and the pixel position in the sub-scanning direction is denoted by m (1≤m). The luminance value of each pixel is denoted by px (x=0 to 8). Then, the difference between a maximum value pmax and a minimum value pmin of luminance values of nine pixels of one block is calculated.

At a point A in FIG. 7, all the nine pixels are present on the guide plate (white), and therefore all the nine pixels are white pixels. Therefore, the difference between pmax and pmin is a small value. On the other hand, as in a point B in FIG. 7, at the boundary between the guide plate (white) and the shadow (gray) cast by the document leading edge, a white pixel and a gray pixel are mixed in the nine pixels, and therefore the difference between pmax and pmin increases.

That is, in a case where this difference between pmax and pmin is larger than a predetermined threshold pth, the pixel is defined as an edge pixel. Specifically, in a case where the following Expression (1) is satisfied, a center pixel (pixel of coordinates (n, m)) is determined as an edge pixel.

$$pmax - pmin \geq pth \qquad ( Expression 1 )$$

This determination processing is sequentially performed on each pixel input to the edge extraction module 206.

Reference numeral 701 denotes image data in which the image data 700 is binarized with the threshold pth=14, and the pixels indicated in white are edge pixels satisfying the above Expression (1). In this manner, the shadow cast by the leading edge portion of the document is determined as an edge.

The binary data output from the edge extraction module 206 is transmitted to the front-side registration calculation module 207. The front-side registration calculation module 207 calculates document registration information from the binary data output from the edge extraction module 206.

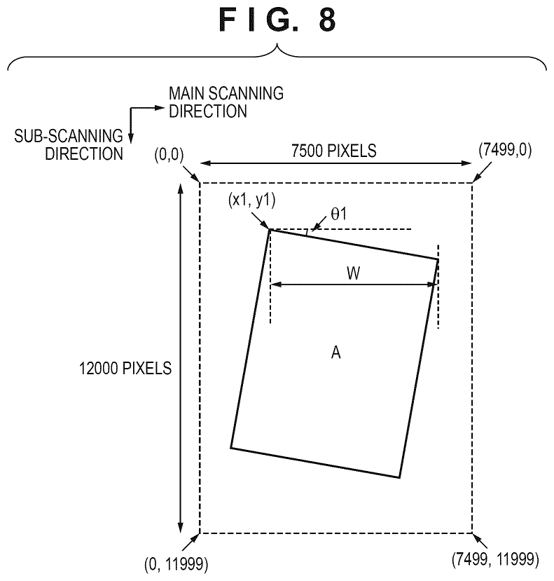

FIG. 8 depicts a view for describing a method for calculating registration in the front-side registration calculation module 207 according to the first embodiment.

As described above, since the image data is input to the edge extraction module 206 from the timing before the document reaches the front-side reading position F, the binary data in the range indicated by the dotted line in FIG. 8 is input to the front-side registration calculation module 207. In the first embodiment, image data in the range from coordinates (0, 0) to coordinates (7499, 11999) is input.

The front-side registration calculation module 207 according to the first embodiment calculates, from this binary data, a document leading edge angle θ1 of a front-side image, the angle direction (=sign), upper left coordinates (x1, y1), and a width W in the main scanning direction at the document leading edge, and transmits them to the CPU 203. Note that in the first embodiment, an upward rightward direction is defined as a positive direction, and a downward rightward direction is defined as a negative direction.

The CPU 203 outputs, to the registration correction module 208, the document leading edge angle θ1, the angle direction, and the upper left coordinates (x1, y1) calculated by the front-side registration calculation module 207. The registration correction module 208 reads the image data of the front side stored in the image memory 205 while performing registration correction using the document leading edge angle θ1, the angle direction, and the upper left coordinates (x1, y1). For this correction, for example, a general affine transformation or the like is used.

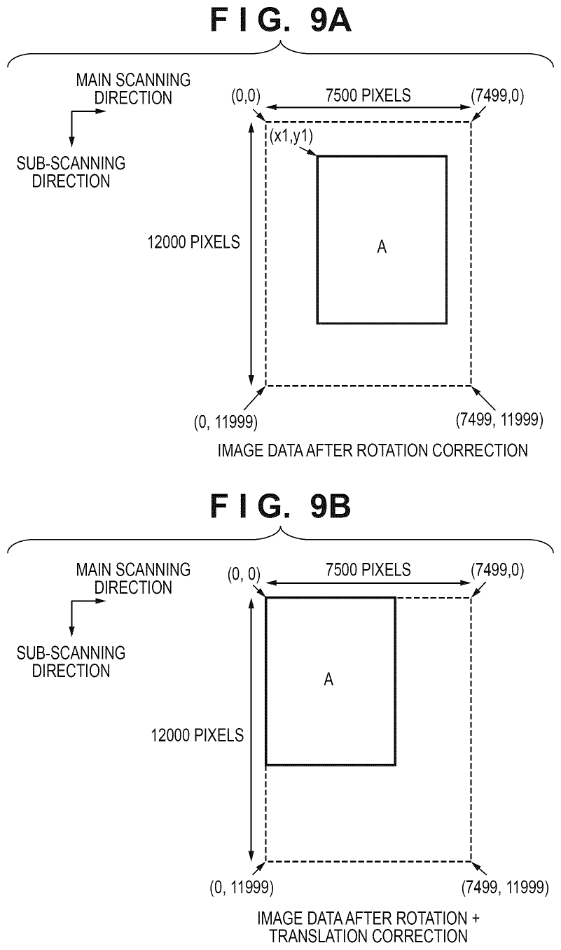

FIGS. 9A and 9B depict views for describing processing of registration correction by the registration correction module 208 according to the first embodiment.

FIG. 9A depicts a view in which the image data illustrated in FIG. 8 is subjected to rotation correction using the document leading edge angle θ1 and the sign of the angle. FIG. 9B depicts a view in which the image data subjected to the rotation correction of FIG. 9A is translated in the main scanning direction and the sub-scanning direction using the upper left coordinates (x1, y1).

By this processing, the image data of the front side is read from the image memory 205 in a state where the upper left coordinates are at the position of (0, 0) and the skew is corrected, and the registration is corrected.

Next, registration correction of the back side will be described.

In the first embodiment, difference information is created in advance, and this difference information is stored in the nonvolatile memory 209. Then, the CPU 203 calculates back-side document information based on the document information on the front side and the width W in the main scanning direction obtained when the document 101 is read, and the difference information stored in the nonvolatile memory 209.

FIG. 10 depicts a view for describing the difference information stored in the nonvolatile memory 209 in the first embodiment. Note that the left side of FIG. 10 is an image indicated by front-side image data before the registration correction is performed, and the right side is an image indicated by back-side image data before the registration correction is performed. Note that the front-side image data and the back-side image data illustrated in FIG. 10 are obtained by conveying a document such as a test chart in advance and causing the front-side reader 109 and the back-side reader 124 to read it.

In the first embodiment, the difference information is coordinates (xF1, yF1) and (xF2, yF2) of two edge positions of the side on the leading edge of the document in the front-side image and coordinates (xR2, yR2) and (xR1, yR1) of two edge positions of the side on the leading edge of the document in a back-side image. Note that the coordinates (xF1, yF1), (xF2, yF2), (xR2, yR2), and (xR1, yR1) of the edge positions can also be obtained by averaging the coordinates of each position obtained by reading a plurality of conveyed documents.

The CPU 203 obtains five values by the following Expressions (2) to (6) from the four values indicated by the difference information.

$$Main scanning direction difference Δ x = ( 7487 - xF 2 ) - xR 1 \qquad Expression ( 2 )$$

$$Sub - scanning direction difference Δ y = yF 2 - yR 1 \qquad Expression ( 3 )$$

$$Front - side skew angle θ F = ( yF 2 - yF 1 ) / ( xF 2 - xF 1 ) \qquad Expression ( 4 )$$

$$Back - side skew angle θ R = ( yR 2 - yR 1 ) / ( xR 2 - xR 1 ) \qquad Expression ( 5 )$$

$$Skew angle difference Δθ = θ F - ( - θ R ) \qquad Expression ( 6 )$$

FIG. 10 schematically illustrates the above five values.

As illustrated in FIG. 10, Δx and Δy indicate differences in the image between the position coordinates of a corner portion of the document in the front-side image data and the position coordinates of a corner portion of the document in the back-side image data corresponding to the corner portion. Note that because the contour of the document 101 is mirror-symmetrical in the front-side image and the back-side image, the difference in position coordinates due to mirror-symmetry is corrected. Specifically, the upper right position (coordinates (xF2, yF2)) of the document in the front-side image of FIG. 10 corresponds to the upper left position (coordinates (xR1, yR2)) of the document in the back-side image of FIG. 10. Considering the mirror symmetry, the coordinates (xF2, yF2) become the coordinates (7487xF2, yF2) in the back-side image. Therefore, the difference (Δx, Δy) of the position is the difference (Δx, Δy)=(7487−xF2−xR1, yF2−yR1). Δθ indicates the difference between the inclination of a leading edge of the document in the front-side image data with respect to the main scanning direction and the inclination of a leading edge of the document in the back-side image data with respect to the main scanning direction.

Next, the CPU 203 obtains the back-side document information by the following Expressions (7) to (9) based on the angle θ1 and the coordinates (x1, y1) of a first position indicated by the front-side document information obtained when the document 101 is read, the width W in the main scanning direction, and the above-described Δx, Δy, and Δθ. That is, coordinates (x2, y2) and an angle θ2 of a second position are calculated.

$$x 2 = 7 \; 487 - ( x 1 + W ) - Δ x \qquad Expression ( 7 )$$

$$y 2 = y 1 + ( W \times tan θ 1 ) - Δ y \qquad Expression ( 8 )$$

$$θ2 = ( θ1 - Δθ ) \times ( - 1 ) \qquad Expression ( 9 )$$

Here, the second position is a position in the back-side image at a position different from the first position of the two edge portions of the leading edge of the document 101. The angle θ2 is an angle of the leading edge in the back-side image with respect to the reference direction (main scanning direction). The CPU 203 transmits, to the registration correction module 208, the back-side document information calculated by the Expressions (7) to (9). Similarly to the front-side image data, the registration correction module 208 performs registration correction on the back-side image data based on the back-side document information.

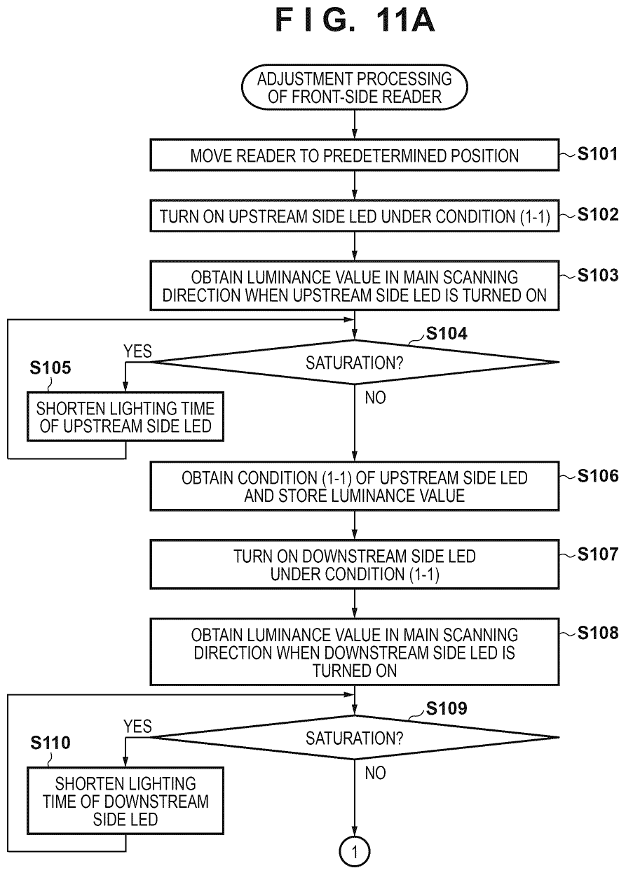

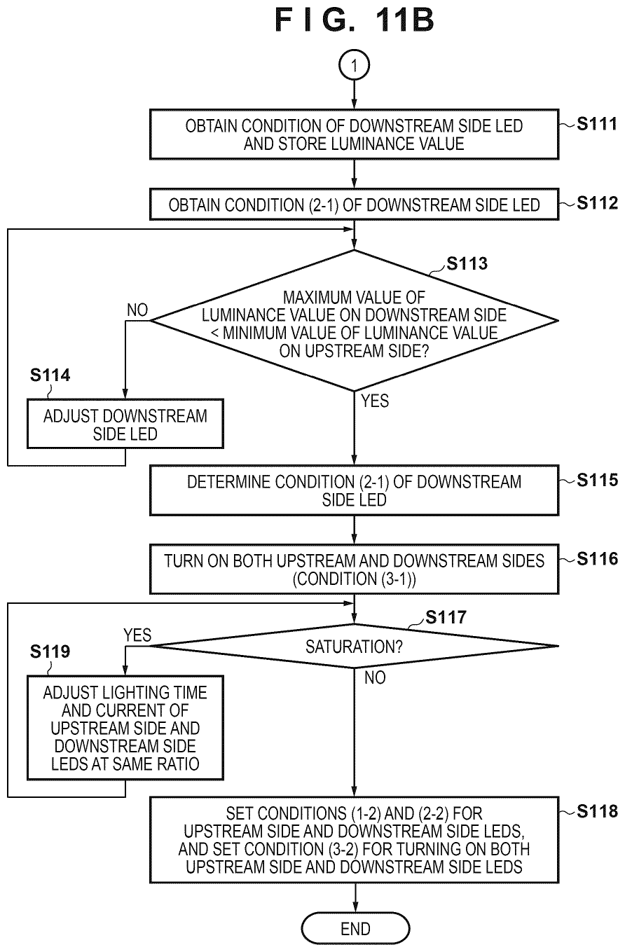

FIGS. 11A and 11B are flowcharts for describing processing of setting the lighting conditions of the upstream side LED 110A and the downstream side LED 110B of the front-side reader 109 in the document reader 100 according to the first embodiment. Note that the processing shown in this flowchart is implemented by the CPU 203 of the controller 200 executing a program stored in the nonvolatile memory 209.

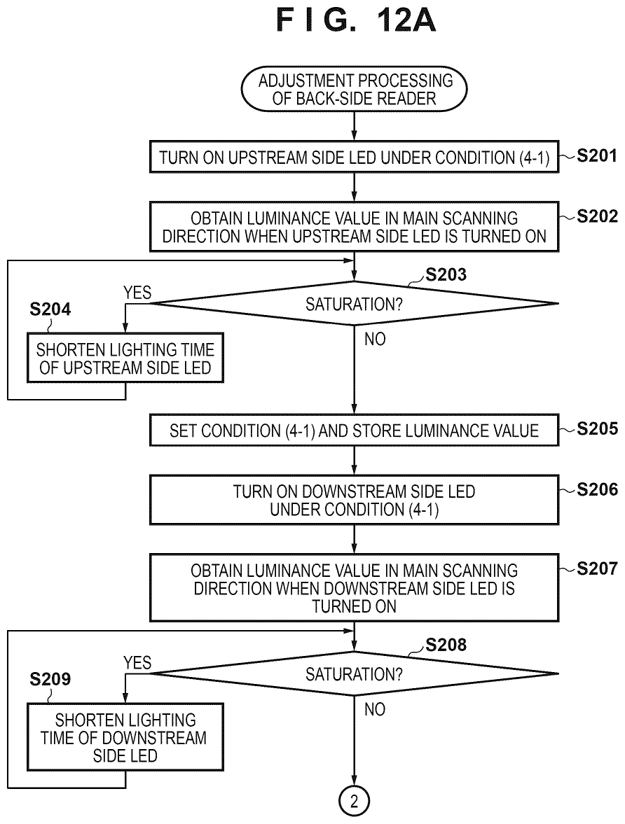

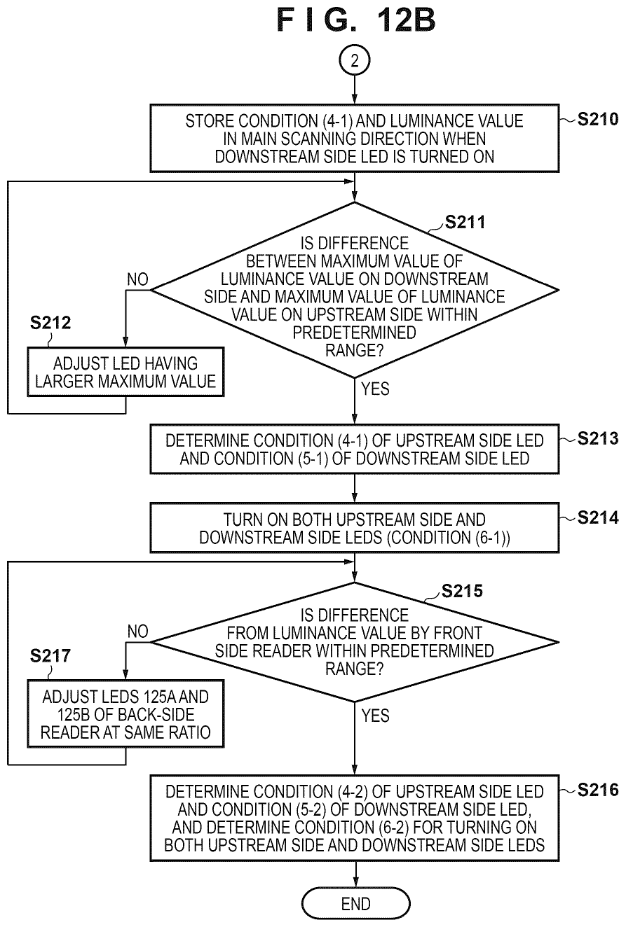

This processing is started, for example, when a request to start light amount adjustment is made from the operation unit 202. However, the present disclosure is not limited to this, and may be started by an instruction from a PC or a mobile terminal connected via an interface, for example. In the processing described below with reference to FIGS. 11 and 12, data such as each condition and a luminance value are stored in the RAM 203a or the nonvolatile memory 209.

When the request to start light amount adjustment is input, the CPU 203 moves the front-side reader 109 below the white reference plate 122 in step S101. Next, the process proceeds to step S102, and the CPU 203 turns on the upstream side LED 110A under a predetermined condition (here, condition (1-1)) set in advance. Condition (1-1) at this time is, for example, the lighting time of 300 μs and the driving current of 50 mA. Next, the process proceeds to step S103, and the CPU 203 converts the light emitted from the upstream side LED 110A, reflected, and condensed into image data by the image sensor 111 and the AFE unit 131 and stores it in the nonvolatile memory 209. At this time, the luminance value in the main scanning direction is obtained and stored in the nonvolatile memory 209. Next, the process proceeds to step S104, and the CPU 203 determines whether the obtained luminance value is “less than” the predetermined value (e.g., “200”, slightly smaller than the maximum value), and in a case of less than the predetermined value, the process proceeds to step S106. However, in a case where the luminance value is the predetermined value or more, the process proceeds to step S105, the CPU 203 shortens the lighting time of the LED 110A by a predetermined amount, and the process proceeds to step S104. In a case that the lighting time of the LED 110A is obtained so as to be less than the predetermined value in step S104, the process proceeds to step S106, the CPU 203 overwrites, as condition (1-1), the driving condition of the upstream side LED 110A at that time and stores the luminance value at that time, and the process proceeds to step S107.

In step S107, the CPU 203 turns off the upstream side LED 110A, and turns on the downstream side LED 110B with the driving condition of the upstream side LED 110A being the condition same as condition (1-1). Next, the process proceeds to step S108, and the CPU 203 converts the light emitted from the downstream side LED 110B, reflected, and condensed into image data by the image sensor 111 and the AFE unit 131. Then, the luminance value in the main scanning direction is obtained. Next, the process proceeds to step S109, similarly to step S104, the CPU 203 determines whether the obtained luminance value is the predetermined value (200) or more, and if it is less than the predetermined value, the process proceeds to step S111. However, if it is the predetermined value or more, the process proceeds to step S110, the CPU 203 shortens the lighting time of the LED 110B by a predetermined amount, and the process proceeds to step S109. When the lighting time of the LED 110B in which no saturation is generated is obtained in this manner, the process proceeds to step S111, the CPU 203 stores the driving condition of the downstream side LED 110B at that time and the luminance value at that time, and the process proceeds to step S112. In this manner, in step S112, the CPU 203 obtains the driving condition of the downstream side LED 110B, which is condition (2-1) here, and stores it in the RAM 203a, for example.

Next, the process proceeds to step S113, and the CPU 203 determines whether the maximum value of the luminance value in the document reading range by the downstream side LED 110B obtained in step S111 is smaller than the minimum value of the luminance value in the document reading range by the upstream side LED 110A obtained in step S106. When this condition is satisfied in step S113, the process proceeds to step S115. Otherwise, the process proceeds to step S114, the CPU 203 shortens the lighting time of the downstream side LED 110B or reduces the driving current, and the process proceeds to step S113. In this manner, when the maximum value of the luminance value in the document reading range by the downstream side LED 110B becomes smaller than the minimum value of the luminance value in the document reading range by the upstream side LED 110A, the process proceeds to step S115. In step S115, the CPU 203 defines the lighting time or the current value of the downstream side LED 110B as condition (2-1). Note that in step S113, the CPU 203 determines whether the luminance value in the document reading range by the upstream side LED 110A is larger than the luminance value in the document reading range by the downstream side LED 110B, and the difference thereof is a predetermined value (e.g., within the luminance difference of 10) or less.

Then, the process proceeds to step S116, and the CPU 203 turns on the upstream side LED 110A under condition (1-1) obtained in step S106, and turns on the downstream side LED 110B under condition (2-1) obtained in step S115. Then, the lighting condition when both the upstream side LED 110A and the downstream side LED 110B are turned on is defined as condition (3-1).

Then, the process proceeds to step S117, and the CPU 203 determines whether the luminance value when both the upstream side LED 110A and the downstream side LED 110B are turned on under condition (3-1) is less than the predetermined value (200). Here, if the maximum value of the luminance value is less than the predetermined value, the process proceeds to step S118.

On the other hand, in a case that it is determined to be the predetermined value or more, the process proceeds to step S119, and the CPU 203 adjusts condition (1-1) and condition (2-1) at the same ratio so that the obtained luminance value becomes less than the predetermined value. In the first embodiment, each of the lighting time and the current value set under condition (1-1) and condition (2-1) is reduced by 2%. Then, the process proceeds to step S117, and in a case that it is determined that the luminance value is less than the predetermined value, the process proceeds to step S118. In step S118, the CPU 203 stores, in the nonvolatile memory 209, the luminance value when both the upstream side LED 110A and the downstream side LED 110B are turned on. Then, the lighting condition of the upstream side LED 110A at this time is defined as condition (1-2), and the lighting condition of the downstream side LED 110B is defined as condition (2-2). Then, the setting when turning on both the upstream side LED 110A and the downstream side LED 110B under these conditions is stored in the nonvolatile memory 209 as condition (3-2), and this processing is ended. Note that after this control flow, the control flow in FIGS. 12A and 12B described later is started.

The processing described above makes it possible to obtain the optimum driving condition (condition (3-2)) when both the upstream side LED 110A and the downstream side LED 110B are turned on when the front side of the document is read by the front-side reader 109.

FIGS. 12A and 12B are flowcharts for describing control processing of setting the lighting conditions of the upstream side LED 125A and the downstream side LED 125B of the back-side reader 124 in the document reader 100 according to the first embodiment. Note that the processing shown in this flowchart is implemented by the CPU 203 of the controller 200 executing a program stored in the nonvolatile memory 209.

When the request to start light amount adjustment is made, the CPU 203 turns on the upstream side LED 125A with a predetermined current and lighting time (condition (4-1)) set in advance in step S201. Here, similarly to condition (1-1), condition (4-1) is the lighting time of 300 μs and the driving current of 50 mA.

Next, the process proceeds to step S202, and the CPU 203 converts the light emitted from the upstream side LED 125A, reflected, and condensed into image data by an image sensor on the back side not illustrated and an AFE unit on the back side not illustrated. In this manner, the luminance value in the main scanning direction is obtained and stored. Then, the process proceeds to step S203, and, similarly to step S104 in FIG. 11A, the CPU 203 determines whether the obtained luminance value causes saturation, and if determining that saturation is caused, that is, the luminance value is the predetermined value or more, the process proceeds to step S204. In step S204, the CPU 203 shortens the lighting time of the upstream side LED 125A by a predetermined amount, and the process proceeds to step S203. In this manner, in a case that it is determined in step S203 that the luminance value has not caused saturation, the process proceeds to step S205, and the CPU 203 sets the lighting setting (condition (4-1)) in which saturation is not generated and stores the luminance value at that time.

Next, the process proceeds to step S206, the CPU 203 turns off the upstream side LED 125A, and turns on the downstream side LED 125B at the same current and lighting time (condition (4-1)) as those of the upstream side LED 125A. Then, the process proceeds to step S207, and the CPU 203 converts the light emitted from the downstream side LED 125B, reflected, and condensed into image data by the image sensor on the back side and the AFE unit on the back side, and stores it. Then, the luminance value in the main scanning direction at this time is obtained and stored. Then, the process proceeds to step S208, and the CPU 203 determines whether the luminance value is the predetermined value (200) or more, and in a case that it is determined that the luminance value is the predetermined value or more, the process proceeds to step S209. In step S209, the CPU 203 shortens the lighting time of the downstream side LED 125B by a predetermined amount, and the process proceeds to step S208. In a case that it is determined in step S208 that the luminance value is less than the predetermined value (200), the process proceeds to step S210, and the CPU 203 obtains the lighting time of the downstream side LED 125B at that time, defines it as condition (4-1), and stores the luminance value at that time.

Next, the process proceeds to step S211, and the CPU 203 determines whether the difference between the maximum value of the luminance value in the document reading range by the downstream side LED 125B stored in step S210 and the maximum value of the luminance value in the document reading range by the upstream side LED 125A stored in step S205 is within a predetermined range. This predetermined range is, for example, a luminance difference of ±10. In a case that it is not within the predetermined range, the process proceeds to step S212, the CPU 203 shortens the lighting time of the LED having the larger maximum value of the maximum values of the upstream side LED 125A and the downstream side LED 125B, or reduces the current, and the process proceeds to step S211. In this manner, when the difference between the maximum value of the larger luminance value and the maximum value of the smaller luminance value falls within the predetermined range in step S211, the process proceeds to step S213. In step S213, the CPU 203 stores the lighting condition of the upstream side LED 125A at this time as condition (4-1) and the lighting condition of the downstream side LED 125B as condition (5-1).

Next, the process proceeds to step S214, and the CPU 203 turns on the upstream side LED 125A under condition (4-1) and simultaneously turns on the downstream side LED 125B under condition (5-1). The lighting conditions of the upstream side LED and the downstream side LED at this time are defined as condition (6-1). The luminance value when both the upstream side LED 125A and the downstream side LED 125B are turned on under the lighting condition of condition (6-1) is obtained and stored in the nonvolatile memory 209.

Next, the process proceeds to step S215, and the CPU 203 determines whether the luminance value by the front-side reader 109 stored in step S118 of the flowchart of FIG. 11B falls within a predetermined range (luminance difference of within ±4 in the first embodiment). That is, here, it is determined whether the difference between the total light amount when both the upstream side LED 110A and the downstream side LED 110B of the front-side reader 109 are turned on and the total light amount when both the upstream side LED 125A and the downstream side LED 125B of the back-side reader 124 are turned on is within the predetermined range. When it is determined that the difference between the total light amounts falls within the predetermined range, the process proceeds to step S216, and the CPU 203 defines the lighting setting of the upstream side LED 125A at this time as condition (4-2) and defines the lighting setting of the downstream side LED 125B as condition (5-2)). Then, the setting when the LEDs on both sides of the back-side reader 124 are turned on at this time is stored in the nonvolatile memory 209 as condition (6-2), and this processing is ended.

On the other hand, in a case of determining in step S215 that the difference between the total light amounts does not fall within the predetermined range, the process proceeds to step S217, the CPU 203 adjusts the lighting times or the current values of the upstream side LED 125A and the downstream side LED 125B of the back-side reader 124 at the same ratio, and the process proceeds to step S215. In this manner, in step S215, in a case that the difference between the total light amount of the front-side reader 109 and the total light amount of the back-side reader 124 falls within the predetermined range, the process proceeds to step S216. In step S216, the CPU 203 obtains the lighting condition (condition (4-2)) of the upstream side LED 125A and the lighting condition (condition (5-2)) of the downstream side LED 125B of the back-side reader 124 at that time. Then, the setting when turning on both of the upstream side LED 125A and the downstream side LED 125B of the back-side reader 124 is stored as condition (6-2) in the nonvolatile memory 209, and this processing is ended.

The processing described above makes it possible to obtain the optimum driving condition (condition (6-2)) of the upstream side LED 125A and the downstream side LED 125B when the back side of the document is read by the back-side reader 124.

Then, in a case where the document is read by the ADF, the upstream side LED 110A and the downstream side LED 110B of the front-side reader 109 are turned on under condition (3-2), and the upstream side LED 125A and the downstream side LED 125B of the back-side reader 124 are turned on under condition (6-2).

As described above, according to the first embodiment, it is possible to accurately detect the shadow edge generated at the leading edge of the document by setting the driving conditions of the LEDs of the front-side reader when the document is read by turning on both the upstream side and downstream side LEDs of the front-side reader. The image data read by the back-side reader can be corrected using the shadow edge information detected by the front-side reader. Furthermore, there is an effect that the quality (S/N ratio) of the image data read by the front-side reader and the image data read by the back-side reader can be made equal.

### Second Embodiment

Next, a second embodiment of the present disclosure will be described. Note that since the configuration of the document reader 100 according to the second embodiment is similar to that of the first embodiment described above, the description thereof will be omitted.

In the second embodiment, the processing in step S215 in the flowchart of FIG. 12B of the first embodiment is different.

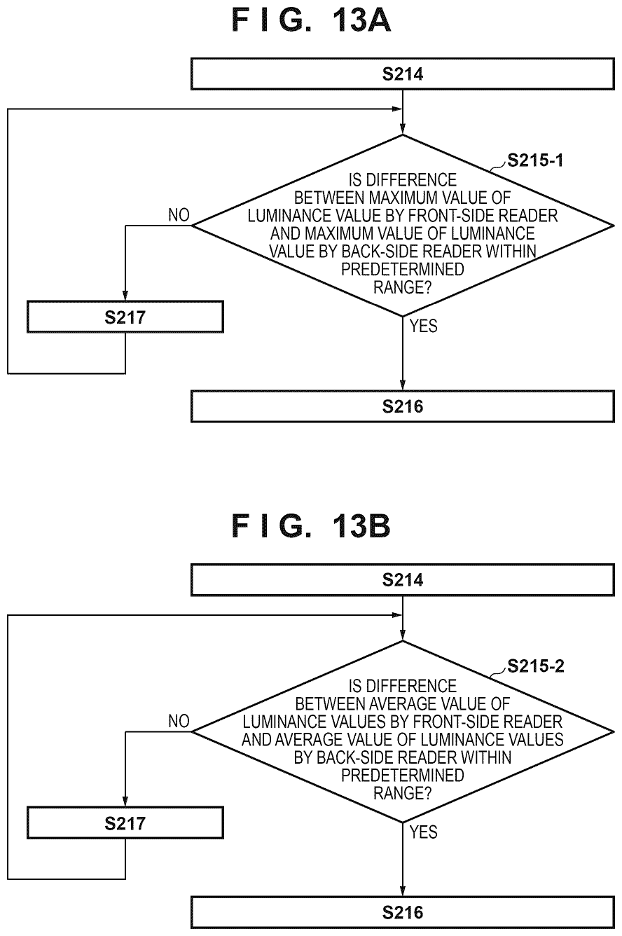

FIG. 13A is a flowchart for describing the processing corresponding to step S215 of the flowchart of FIG. 12B according to the second embodiment.

In step S215-1 of FIG. 13A, the CPU 203 compares the maximum value of the luminance value by the front-side reader 109 stored in step S118 with the maximum value of the luminance value by back-side reader 124 obtained in step S214. Then, it is determined whether the difference between the maximum values is within a predetermined range, for example, a luminance difference of ±4. In a case that it is determined that the difference is within the predetermined range, the process proceeds to step S216, and condition (6-2) when turning on both the upstream side LED 125A and the downstream side LED 125B is set. On the other hand, in a case that it is determined that the difference between the maximum values is not within the predetermined range, the process proceeds to step S217, the CPU 203 adjusts the lighting times or the current values of the upstream side LED 125A and the downstream side LED 125B of the back-side reader 124 at the same ratio, and the process proceeds to step S215-1.

Thus, according to the second embodiment, similar effects to those of the first embodiment can be obtained.

### Third Embodiment

Next, the third embodiment of the present disclosure will be described. Note that since the configuration of the document reader 100 according to the third embodiment is similar to that of the first embodiment described above, the description thereof will be omitted.

In the third embodiment, the processing in step S215 in the flowchart of FIG. 12B of the first embodiment is different.

FIG. 13B is a flowchart for describing the processing corresponding to step S215 of the flowchart of FIG. 12B according to the third embodiment.

In step S215-2 of FIG. 13B, the CPU 203 compares the average value of the luminance values in the main scanning direction of the front-side reader 109 stored in step S118 with the average value of the luminance values in the main scanning direction of the back-side reader 124 obtained in step S214. Then, it is determined whether the difference between the average values is within a predetermined range, for example, a luminance difference of ±4. In a case that it is determined that the difference is within the predetermined range, the process proceeds to step S216, and condition (6-2) when turning on both the upstream side LED 125A and the downstream side LED 125B is set. On the other hand, in a case that it is determined that the difference between the average values is not within the predetermined range, the process proceeds to step S217, the CPU 203 adjusts the lighting times or the current values of the upstream side LED 125A and the downstream side LED 125B of the back-side reader 124 at the same ratio, and the process proceeds to step S215-2.

Thus, according to the third embodiment, similar effects to those of the first embodiment can be obtained.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to Japanese Patent Application No. 2025-042624, which was filed on Mar. 17, 2025, and which is hereby incorporated by reference herein in its entirety.

What is claimed is:

1. An image reading apparatus that reads a document conveyed by a conveyor, the image reading apparatus comprising:
a first image reader that includes a first light source disposed on an upstream side in a conveyance direction of the document and a second light source disposed on a downstream side in the conveyance direction, and reads a first side of the document with light emitted by the first light source and the second light source;
a second image reader that includes a third light source on an upstream side in the conveyance direction of the document and a fourth light source on a downstream side in the conveyance direction, and reads a second side different from the first side of the document with light emitted by the third light source and the fourth light source; and
one or more controllers including one or more processors in communication with one or more memories, the one or more controllers configured to:
be able to adjust a light amount of the first light source and light amount of the second light source, and
be able to adjust a light amount of the third light source and light amount of the fourth light source
wherein when adjusting the light amount of the third light source and the light amount of the fourth light source, the one or more controllers adjust a second total light amount in which the light amount of the third light source and the light amount of the fourth light source are added based on a first total light amount in which the light amount of the first light source and the light amount of the second light source whose light amounts have been adjusted are added.

2. The image reading apparatus according to claim 1, wherein when adjusting the light amount of the first light source and the light amount of the second light source, the one or more controllers obtain a first condition when turning on both the first light source and the second light source by adjusting so that the light amount of the second light source is larger than the light amount of the first light source and a difference between the light amounts becomes a predetermined value or more.

3. The image reading apparatus according to claim 2, wherein when adjusting the light amount of the third light source and the light amount of the fourth light source, the one or more controllers obtain a second condition when turning on both the third light source and the fourth light source by adjusting the light amounts of the third light source and the fourth light source so that a difference between a total light amount when turning on both the first light source and the second light source under the first condition and a total light amount when turning on both the third light source and the fourth light source falls within a predetermined range.

4. The image reading apparatus according to claim 1, wherein the one or more controllers further correct a skew of an image obtained by reading the document by the first image reader based on a shadow cast by the document generated at a leading edge portion of the document read by the first image reader.

5. The image reading apparatus according to claim 1, wherein the one or more controllers further correct a skew of an image obtained by reading the document by the second image reader based on a shadow cast by the document generated at a leading edge portion of the document read by the first image reader.

6. The image reading apparatus according to claim 3, wherein the one or more controllers further control the first image reader under the first condition and control the second image reader under the second condition in reading of the document.

7. The image reading apparatus according to claim 3, wherein when adjusting the light amount of the first light source and the light amount of the second light source, the one or more controllers obtain a condition when turning on the second light source so that a maximum value of a luminance value within a reading range of the document when turning on the second light source is smaller than a minimum value of the luminance value within the reading range when turning on the first light source under a predetermined condition, and obtain the first condition based on the condition and the predetermined condition.

8. The image reading apparatus according to claim 7, wherein when adjusting the light amount of the first light source and the light amount of the second light source, the one or more controllers obtain the condition when turning on the second light source, the condition in which the maximum value of the luminance value within the reading range of the document when turning on the second light source is larger than the minimum value of the luminance value within the reading range when turning on the first light source under the predetermined condition, and a difference between the values is equal to or less than a predetermined value.

9. The image reading apparatus according to claim 3, wherein when adjusting the light amount of the third light source and the light amount of the fourth light source, the one or more controllers adjust the light amounts of the third light source and the fourth light source so that a difference between a maximum value of a light amount when turning on both the first light source and the second light source under the first condition and a maximum value of a light amount when turning on both the third light source and the fourth light source falls within a predetermined range.

10. The image reading apparatus according to claim 3, wherein when adjusting the light amount of the third light source and the light amount of the fourth light source, the one or more controllers adjust the light amounts of the third light source and the fourth light source so that a difference between an average value of a light amount when turning on both the first light source and the second light source under the first condition and an average value of a light amount when turning on both the third light source and the fourth light source falls within a predetermined range.

11. The image reading apparatus according to claim 2, wherein the first condition includes at least any of lighting times of the first light source and the second light source and driving currents of the first light source and the second light source, or both the lighting times and the driving currents.

12. The image reading apparatus according to claim 3, wherein the second condition includes at least any of lighting times of the third light source and the fourth light source and driving currents of the third light source and the fourth light source, or both the lighting times and the driving currents.

13. The image reading apparatus according to claim 10, wherein when adjusting the light amount of the third light source and the light amount of the fourth light source, the one or more controllers adjust the light amount of the third light source and a lighting time or a driving current of the fourth light source at a same ratio.

14. A method of controlling an image reading apparatus including
a conveyor that conveys a document,
a first image reader that includes a first light source disposed on an upstream side in a conveyance direction of the document and a second light source disposed on a downstream side in the conveyance direction, and reads a first side of the document with light emitted by the first light source and the second light source, and
a second image reader that includes a third light source on an upstream side in the conveyance direction of the document and a fourth light source on a downstream side in the conveyance direction, and reads a second side different from the first side of the document with light emitted by the third light source and the fourth light source,
the method comprising:
adjusting a light amount of the first light source and a light amount of the second light source; and
adjusting a light amount of the third light source and a light amount of the fourth light source,
wherein in the adjusting of the light amount of the third light source and the light amount of the fourth light source, a second total light amount in which the light amount of the third light source and the light amount of the fourth light source are added is adjusted based on a first total light amount in which the light amount of the first light source and the light amount of the second light source that have been adjusted are added.

15. The method according to claim 14, wherein in the adjusting of the light amount of the first light source and the light amount of the second light source, a first condition when turning on both the first light source and the second light source is obtained by adjusting so that the light amount of the second light source is larger than the light amount of the first light source and a difference between the light amounts becomes a predetermined value or more.

16. The method according to claim 15, wherein in the adjusting of the light amount of the third light source and the light amount of the fourth light source, a second condition when turning on both the third light source and the fourth light source is obtained by adjusting the light amounts of the third light source and the fourth light source so that a difference between a total light amount when turning on both the first light source and the second light source under the first condition and a total light amount when turning on both the third light source and the fourth light source falls within a predetermined range.
